(19) United States
(12) Patent Application Publication
(10) Pub. No.: US 2015/0233736 A1
(43) Pub. Date: Aug. 20, 2015

(54) MEASURING ARRANGEMENT

(71) Applicant: ZF FRIEDRICHSHAFEN AG, FRIEDRICHSHAFEN (DE)

(72) Inventor: Josef HABENSCHADEN, Kohlberg (DE)

(21) Appl. No.: 14/575,750

(22) Filed: Dec. 18, 2014

(30) Foreign Application Priority Data
Dec. 18, 2013 (DE) 10 2013 226 516.6

(51) Int. Cl. G01D 5/20; G01M 13/02; F16H 63/30

(52) U.S. Cl. CPC G01D 5/2006; F16H 63/30; G01M 13/022; F16H 2063/3093

(57) ABSTRACT

A measurement assembly, in particular for a transmission, having a rotating assembly and having a sensor system that is stationary in relation to the rotating assembly, for detecting a direction of rotation and/or a rate of rotation and/or a rotational position and/or an axial position of the rotating assembly, wherein the rotating assembly has an encoding comprised of holes and/or projections on an axial end surface and/or on a radial circumferential surface, which moves in relation to the stationary sensor system when the rotating assembly rotates; and wherein the stationary sensor system has at least two sensor, disposed adjacently to one another, in which eddy currents can be induced, dependent on the rotational movement of the encoding thereon, wherein the direction of rotation and rate of rotation and the rotational position and the axial position of the rotating assembly can be determined from impulses of the measurement signals of the sensors, which are dependent on the induced eddy currents.

This application is a filing under 35 U.S.C. §371 of Germany Patent Application DE 10 2013 226 516.6, filed Dec. 18, 2013, which is incorporated by reference herein in its entirety.

The invention relates to a measurement assembly according to the preamble of claim 1. Furthermore, the invention relates to a transmission and a drive having such a measurement assembly.

Shift elements, designed for example as claw clutches, are installed in motor vehicle transmissions, which must be engaged and disengaged. To enable a correct engagement and disengagement of such shift elements, it is important that the direction of rotation, the rate of rotation, and the rotational position, as well as the axial position, of at least one rotating assembly of the form-locking shift element be determined exactly in order to activate the disengagement and engagement of the form-locking shift element in an exact manner, based on these parameters for the respective rotating assembly. The exact and simple determination of the above parameters poses difficulties for the measurement assemblies known from the prior art.

A rotary speed sensor having detection of the direction of rotation is known from DE 199 60 891 A1, which uses polarized permanent magnets. The use of such permanent magnets for detecting the direction of rotation is, in particular, not suited for use in motor vehicle transmissions, because the permanent magnets can become damaged or destroyed as a result of the temperatures prevailing in the motor vehicle transmissions. Furthermore, such permanent magnets attract loose metal shavings, which can collect on the permanent magnets. As a result, such permanent magnets become contaminated when used in motor vehicle transmissions, and can then no longer be used, because the metal shavings collecting on the permanent magnets make a detection impossible. A cleaning of the permanent magnets is as good as impossible. There is a similar problem when the rate of rotation, the direction of rotation, and the rotational position of a rotating assembly in an electric machine, which is installed in a hybrid drive or electric drive of a motor vehicle, are to be detected.

For this reason, there is a need for a measurement assembly which also enables a reliable detection of the direction of rotation, the rate of rotation, the rotational position and the axial position of a rotating assembly when used in a transmission or drive of a motor vehicle.

Based on this, the present invention addresses the objective of creating a novel measurement assembly and a transmission as well as a drive having such a measurement assembly.

This objective is attained by means of a measurement assembly according to claim 1. The measurement assembly according to the invention comprises a rotating assembly and a sensor system that is stationary in relation to the rotating assembly, wherein the rotating assembly has an encoding comprised of holes and/or projections on an axial end surface and/or on a radial circumferential surface, which moves in relation to the stationary sensor system when the rotating assembly rotates, and wherein the stationary sensor system has at least two sensors, disposed adjacently to one another, in which eddy currents can be induced, dependent on the rotational movement of the rotating assembly, specifically dependent on the rotational movement of the encoding thereon, wherein the direction of rotation and the rate of rotation and the rotational position and the axial position of the rotating assembly can be determined from impulses of the measurement signals, which are dependent on the induced eddy currents.

The measurement assembly according to the invention is simple and enables a reliable determination of the direction of rotation, the rate of rotation, and the rotational position, as well as the axial position, of a rotating assembly, this also being possible in operating conditions prevailing in a motor vehicle transmission or a motor vehicle drive, respectively. The measurement assembly according to the invention uses an encoding allocated to the rotating assembly thereby, comprised of holes and/or projections, which moves in relation to the stationary sensor system when the rotating assembly rotates. The measurement signals of the at least two sensors in the sensor system enable a determination of the above parameters, specifically the direction of rotation, the rate of rotation, the rotational position, and the axial position of the respective rotating assembly.

Preferably, the axial position of the rotating assembly can be determined from the amplitudes of the impulses of the measurement signals of the sensors. The rotational rate of the rotating assembly can be determined from the frequency of the impulses of the measurement signals of the sensors. The direction of rotation and the rotational position of the rotating assembly can be determined from the sequence and the number of impulses of the measurement signals of the sensors.

The above parameters can be readily and reliably determined from the amplitudes and frequency, as well as the sequence and number of impulses of the measurement signals of the sensors.

According to a further development, the encoding is formed by holes and/or projections, such that the distribution, in particular, the number and/or sequence, and/or the geometry, in particular the shape and/or dimensions, of the holes and/or projections changes in at least one circumferential section of the end surface and/or the circumferential surface as seen over the circumference of the axial end surface and/or over the circumference of the radial circumferential surface. This design for the encoding is simple and enables a reliable determination of the above parameters.

The transmission according to the invention contains a shift element comprising a first rotating assembly, specifically a first shift element disk, and a second rotating or stationary assembly, specifically a second shift element disk, as well as at least one measurement assembly according to the invention, wherein a sensor system is allocated to at least the first rotating shift element disk, which serves to determine the direction of rotation and the rate of rotation and the rotational position of the first shift element disk, as well as the axial position of the first shift element disk, and thus the axial spacing between the first shift element disk and the second shift element disk. The use of the measurement assembly according to the invention in a transmission, in particular for a motor vehicle, is particularly preferred.

The drive according to the invention contains an electric machine having a rotating assembly, wherein the sensor system is allocated to the rotating assembly, and serves for the determination of at least the direction of rotation and the rate of rotation and the rotational position of the rotating assembly.

Preferred further developments of the invention can be derived from the dependent claims and the following description. Embodiment examples of the invention shall be explained in greater detail based on the drawings, without being limited thereto. Shown are:

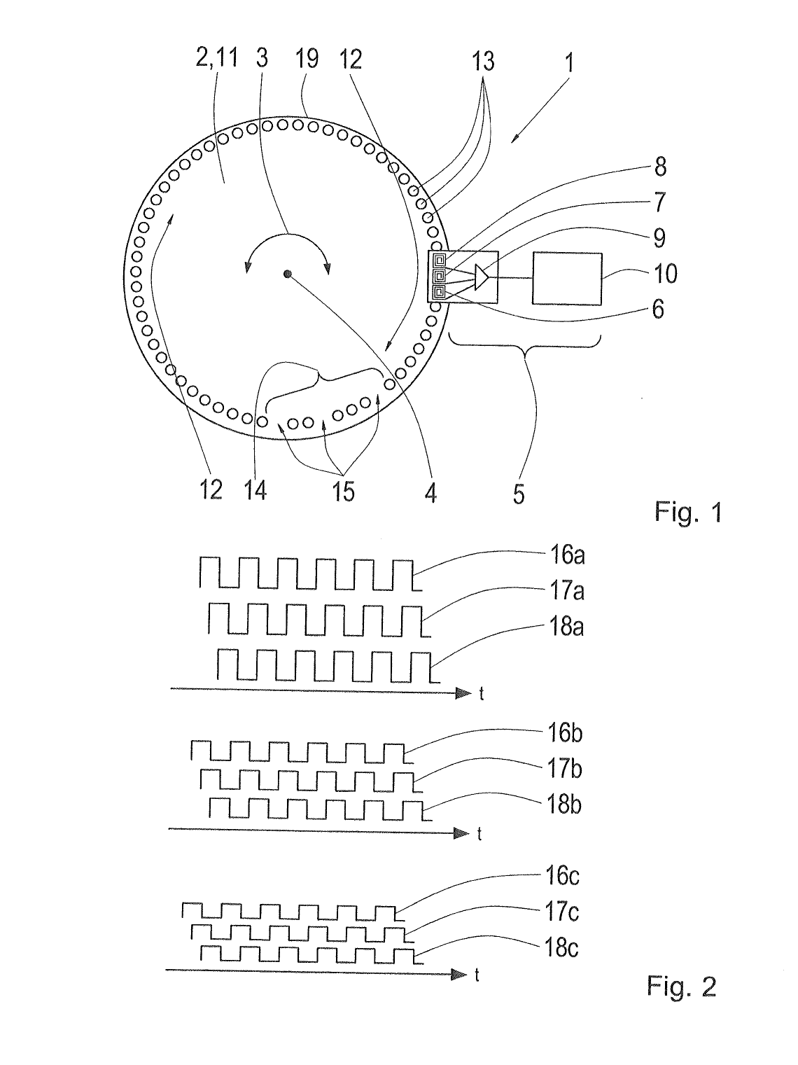

FIG. 1 a schematic depiction of a measurement assembly according to the invention; and

FIG. 2 a schematic measurement signal from sensors of the measurement assembly.

The present invention relates to a measurement assembly. A measurement assembly of this type serves to determine the direction of rotation and/or the rate of rotation and/or the absolute rotational position and/or the determination of the axial position of a rotating assembly. In particular, the measurement assembly according to the invention is used in a transmission, preferably a motor vehicle transmission, or a motor vehicle drive, such as a hybrid drive or an electric drive, for example.

FIG. 1 shows a schematic depiction of a measurement assembly 1 according to the invention. The measurement assembly 1 in FIG. 1 comprises a rotating assembly 2, which can rotate in different directions of rotation, about a rotational axis 4, as indicated by the double arrow 3.

Then, when the measurement assembly 1 according to the invention is used in a transmission in a motor vehicle, the rotating assembly 2 is, for example, a rotating shift element disk of a shift element of the transmission, such as a shift element disk of a form-locking shift element, for example, which rotates in relation to a second shift element disk. Form-locking shift elements of this type are also referred to as claw clutches.

The measurement assembly 1 according to the invention also contains a stationary sensor system 5, comprising numerous sensors 6, 7, 8, disposed adjacently to one another. In the embodiment example illustrated in FIG. 1, the stationary sensor system 5 of the measurement assembly 1 according to the invention comprises three sensors 6, 7, and 8, disposed adjacently to one another. It should be noted at this point that the sensor system 5 of the measurement assembly 1 according to the invention can also comprise only two of these sensors, disposed adjacently to one another, or can also comprise more than three sensors.

The measurement signals provided by the sensors 6, 7, and 8 are supplied to an evaluation system 10, via an amplifier 9, for processing the measurement signals provided by the sensors 6, 7, and 8.

In the embodiment example illustrated in FIG. 1, the rotating assembly 2 includes an encoding 12, comprised of numerous holes 13, on one axial end surface 11.

It can be derived from FIG. 1 thereby, that these holes 13, which all have the same geometry in the embodiment example in FIG. 1, specifically an identical shape and an identical size, are distributed over the circumference of the axial end surface 11 such that the distribution of the holes 13 changes in at least one circumferential section 14 of the end surface 11.

Thus, it can be derived from FIG. 1 that no holes 13 are formed at the circumferential position 15 of the circumferential section 14 of the axial end surface 11 of the rotating assembly 2, this being such that in one case, a group of two holes 13 is formed, and in one case, a group of three holes 13 is formed, wherein these groups, of two holes 13 and three holes 13, are separated from one another, as well as from the remaining holes 13 of the encoding 12, by means of the circumferential positions 15 in which no holes 13 are formed.

Depending on the rotational movement of the encoding 12, or the assembly 2 on which the encoding 12 is located, respectively, in relation to the sensors 6, 7, 8 of the sensor system 5, eddy currents are induced in the sensors 6, 7, 8, which are deposited as impulses in the measurement signals provided by the sensors 6, 7, 8, wherein the direction of rotation and the rate of rotation and the rotational position, as well as the axial position of the rotating assembly 2 can be determined from the measurement signals of the sensors 6, 7, and 8 of the measurement system 5 that are dependent on the induced, impulse-like eddy currents.

As has already been explained, the encoding 12 is provided in the illustrated embodiment example in that holes 13 having an identical geometry, specifically an identical shape and identical size, are formed on the axial end surfaces 11 of the rotating assembly 2, wherein these holes 13 are omitted in a circumferential section 14 at defined circumferential positions 15, such that, accordingly, in providing the encoding 12, the evenly distributed pattern of the holes 13 outside the circumferential section 14 is interrupted. The holes 13 are circular in FIG. 1. Alternatively, rhomboid, rectangular or triangular holes can also be used.

In differing from FIG. 1, it is also possible to provide holes of different geometries, specifically of different shapes and/or sizes, at the circumferential positions 15 where there are no holes in the embodiment example in FIG. 1, thus, for example, holes having a smaller or larger diameter, or holes of a different geometric shape. Thus, rhomboid or rectangular or triangular holes, for example, can be provided at the circumferential positions 15. In this case, although all of the holes would be evenly distributed over the circumference of the axial end surface 11, the geometry, in particular the shape, of the holes would then change in at least one circumferential section in a defined sequence.

In a further alternative for the invention, it is possible to form the encoding 12 in the axial end surface 11 of the rotating assembly 2, not by means of holes 13, but rather by means of projections. In this case, the elements 13 would then be cylindrical projections, which are omitted at the circumferential positions 15.

According to a further alternative for the invention, it is possible to design an encoding 12 for the rotating assembly 2 of the measurement assembly according to the invention by means of a combination of holes and projections. As such, for example, in the embodiment example in FIG. 2, at the circumferential position 15 where no holes 13 are formed, a respective projection can be formed.

In the illustrated embodiment example, the encoding 12 is formed on an axial end surface 11 of the rotating assembly 2 of the measurement assembly 1.

In differing to this, it is also possible to form the encoding on a radial circumferential surface 19 of the rotating assembly 2, this being, in turn, by means of holes and/or projections, wherein, seen over the circumference of the radial circumferential surface 19, in at least one circumferential section 14 of the circumferential surface 19, the distribution, in particular the number and/or sequence, and/or the geometry, in particular the shape and/or the size, of the holes 13 and/or projections, changes.

In the embodiment example in FIG. 1, the otherwise uniform distribution of the holes 13 having identical geometrical dimensions is interrupted, specifically at the circumferential positions 15 of the circumferential section 14. It is also possible to make this interruption of the uniform distribution of the holes 13 at two, preferably diametrically opposite, circumferential sections 14, or at more than two circumferential sections, wherein then, however, the circumferential sections 14, at which the uniform distribution of the holes is interrupted in FIG. 1, are embodied in different manners, for example with regard to the sequence of the groups, each having a different number of holes 13, which are separated from one another by the circumferential positions 15. Then, when numerous such circumferential sections 14 are present, the completion of a complete rotation of the rotating assembly 2, and thus the encoding 12, in particular the direction of rotation and the rotational position of the rotating assembly 2, can already be determined, e.g. with two circumferential sections 14 lying diametrically opposite one another, after a 180° rotation of the assembly 2.

With the measurement assembly 1 according to the invention, it is possible to determine the rate of rotation of the rotating assembly 2, the direction of rotation of the rotating assembly 2, the absolute rotational position of the rotating assembly 2, as well as the axial position of the rotating assembly 2. FIG. 2 shows different characteristics of measurement signals 16a, 17a, 18a, 16b, 17b, 18b, 16c, 17c, 18c of the sensors 6, 7, and 8 over time t, wherein these measurement signals of the sensors 6, 7, and 8 differ with respect to the amplitudes of the impulses. The sensors 6, 7, and 8 then provide the measurement signals 16a, 17a, 18a when the axial spacing between the rotating assembly 2 with the encoding 12 to the sensors 6, 7, and 8 of the sensor system 5 is relatively small. The measurement signals 16c, 17c, and 18c are then provided by the sensors 6, 7, and 8 when this axial spacing between the rotating assembly 2 with the encoding 12, and the sensors 6, 7, and 8 of the sensor system 5 is relatively large. The measurement signals 16b, 17b, 18b are then provided by the sensors 6, 7, and 8 when the rotating assembly 2 includes a mid-range axial spacing to the sensors 6, 7, and 8, lying between the relatively large axial spacing and the relatively small axial spacing. In particular with a minimal axial spacing of the encoding to the sensors, a calibration of the spacing measurement is possible, this also being the case during operation.

With different axial spacings between the rotating assembly 2 and the sensors 6, 7, and 8, the so-called damping, of the sensors designed as induction spirals, or induction coils, respectively, changes such that the impulses of the signals 16a-18a caused by the eddy currents induced in the sensors 6, 7, and 8 include a deviating amplitude, dependent on the axial spacing of the rotating assembly 2 to the sensors 6, 7, and 8.

In the evaluation system 10, the amplitudes of the measurement signals of the sensors 6, 7, and 8 can therefore be evaluated in order to determine the axial spacing of the rotating assembly 2 to the sensors 6, 7, and 8 of the sensor system 5, in order to thus, for example in the case of a form-locking shift element, determine the spacing of the rotating assembly 2 to another assembly of the form-locking shift element. In this case, it is then possible to determine, based on the axial spacing, whether the form-locking shift element is engaged, disengaged, or in an intermediate position, e.g. a so-called tooth-to-tooth position.

The rate of rotation of the rotating assembly 2 can be determined from the frequency of the impulses of the measurement signals 16a-18c.

The direction of rotation and the absolute rotational position of the rotating assembly 2 can be determined from the sequence and the number of the impulses of the measurement signals 16a-18c of the sensors 6, 7, and 8. If it has been established, for example, that an impulse in the measurement signals differs from the other impulses in terms of its width, then it can be concluded, based on this, that the rotational position of the rotating assembly 2 corresponds to one of the circumferential positions 15 at which, in the embodiment example in FIG. 1, the otherwise uniformly distributed pattern of the holes 13 has been interrupted. By counting the impulses starting from a detected circumferential position 15, the current absolute rotational position of the rotating assembly 2 can be determined. By monitoring the sequence of the impulses, the direction of rotation of the rotating assembly 2 can be determined, because the groups of holes, separated from one another in FIG. 1 by the circumferential positions 15, differ from one another with respect to their number. Thus, the direction of rotation of the rotating assembly 2 can be determined from the sequence of the impulses in the measurement signals of the sensors 6, 7, and 8.

With the measurement assembly 1 according to the invention, it is therefore possible to determine the direction of rotation and the rotational position and the rate of rotation, as well as the axial position of rotating assemblies, such as disks, drums, or adjustment elements, for example. For this, the rotating assembly 2 has an encoding comprised of holes and/or projections, which are moved past numerous sensors 6, 7, 8 of a stationary sensor system 5. Eddy currents are induced in a pulsating manner in the sensors 6, 7, and 8, that are dependent on the encoding, wherein the above parameters of the rotational movement of the rotating assembly 2 can be determined from the amplitudes and the frequency, as well as the sequence and number of eddy current impulses, specifically, the direction of rotation and the rate of rotation and the rotational position, as well as an axial spacing, or an axial position, respectively, of the turning, or rotating, respectively, assembly 2.

This encoding 12 can, as has already been stated, be provided by holes and/or projections, wherein the holes can be circular holes or oblong holes, or rhomboid holes, or triangular holes, or suchlike. The holes can be formed by means of drilling, stamping, or milling. When circular holes are used, the impulses of the measurement signals are characterized by dramatic flanks. With rhomboid holes, the flanks of the impulses of the measurement signals run in a linear manner. With triangular holes, the flanks of the impulses of the measurement signals also run in a linear manner, wherein, with the use of triangular holes, the direction of rotation can already be detected after one rotation of the assembly in the angular range that has been set. As has already been explained, a combination of holes having different contours can be used as well, i.e. circular holes in combination with rhomboid holes, for example.

The encoding 12 of the rotating assembly 2 is formed by holes and/or projections such that in at least one circumferential section 14 of the end surface 11 and/or the circumferential surface 19, seen over the circumference of the axial end surface 11 and/or over the circumference of the radial circumferential surface 19, the distribution changes, in particular the number and/or sequence, and/or the geometry, in particular the shape and/or size, of the holes 13 and/or projections.

For this it is possible that the holes 13 and/or the projections are distributed evenly over the circumference of the axial end surface 11 and/or the radial circumferential surface 19, wherein the geometry of the holes 13 and/or the projections changes in a defined sequence in at least one circumferential section 14. Furthermore, it is possible that holes 13 and/or projections having identical geometries are distributed over the circumference of the axial end surface 11 and/or the radial circumferential surface 19, wherein the distribution of the holes 13 and/or the projections changes in at least one circumferential section 14.

It should be noted at this point that an imbalance can be caused by the encoding 12 in the rotating assembly 2. An imbalance of this type can be compensated for by means of additional balancing holes, or balancing projections, respectively, which are formed in another section of the rotating assembly 2 outside of the encoding 12.

As has already been explained, it is significant to the present invention that the distribution and/or geometry of the holes 13 and/or projections forming the encoding 12 changes over the circumference of the end surface 11 and/or circumferential surface 19 on which the encoding 12 is formed. The distribution, in particular the number and/or sequence, and/or the geometry, in particular the shape and/or size, of the holes 13 and/or the projections changes in at least one circumferential section 14 of the end surface 11 and/or the circumferential surface 19, such that the direction of rotation and the rate of rotation and the absolute rotational position and the axial position of the rotating assembly can be determined.

For this, at least two groups are formed in at least one circumferential section 14 of the end surface 11 and/or the circumferential surface 19 of the assembly 2, each having a different number of holes and/or projections, or different geometries of the holes and/or projections, but with an identical distribution of the holes and/or projections within the respective groups, wherein the uniform distribution of the holes and/or projections is interrupted between the groups, or holes and/or projections having a deviating geometry are disposed between the groups.

In FIG. 1, two groups having different numbers of holes 13 are formed in the circumferential section 14, wherein the holes 13 of the two groups have an identical geometry, and wherein the groups are separated from one another by the circumferential position 15 in which no holes are formed. Alternatively, it would also be possible to provide two groups having an identical number of holes in the circumferential section 14, wherein the holes in the groups differ, however, in shape. Likewise, it would also be possible, for example, to provide one group with holes and one group with projections in the circumferential section 14.

The measurement assembly 1 according to the invention is used, in particular, in transmissions or drive systems. In transmissions, it is possible with the measurement assembly 1 according to the invention to monitor the rotational movement and axial displacement of a rotating assembly of a preferably form-locking shift element of the transmission. In a drive system, the rotational movement, in particular, of a rotor in an electric machine, can be monitored with respect to its absolute rotational position, direction of rotation, and rate of rotation.

### REFERENCE SYMBOLS

1 measurement assembly
2 component
3 direction of rotation
4 axis of rotation
5 sensor system
6 sensor
7 sensor
8 sensor
9 amplifier
10 evaluation system
11 end surface
12 encoding
13 hole
14 circumferential section
15 circumferential position
16a, 16b, 16c measurement signal
17a, 17b, 17c measurement signal
18a, 18b, 18c measurement signal
19 circumferential surface

1-10. (canceled)

11. A measurement assembly, comprising:
a sensor system including at least two sensors disposed adjacently to one another;
a rotating assembly rotatable with respect to the sensor system, the rotating assembly including an axial end surface or a radial circumferential surface; and
an encoding including a plurality of holes or projections on the axial end surface or the radial circumferential surface, the encoding configured to pass by the at least two sensors during a rotation of the rotating assembly,
wherein when the encoding passes by the at least two sensors, the at least two sensors generate measurement signals for determining a direction of the rotation, a rate of the rotation, a rotational position, and an axial position of the rotating assembly.

12. The measurement assembly according to claim 11, wherein the axial position of the rotating assembly is determined from amplitudes of the measurement signals.

13. The measurement assembly according to claim 11, wherein the rate of rotation of the rotating assembly is determined from a frequency of the measurement signals.

14. The measurement assembly according to claim 11, wherein the direction of rotation and the rotational position of the rotating assembly are determined from a sequence and a number of the measurement signals.

15. The measurement assembly according to claim 11, wherein the at least two sensors includes induction spirals or induction coils.

16. The measurement assembly according to claim 11, wherein a distribution of the plurality of holes or projections of the encoding changes in number, sequence, and/or geometry in a section along a circumference of the axial end surface or along the radial circumferential surface.

17. The measurement assembly according to claim 11, wherein the plurality of holes or projections are distributed evenly along a circumference of the axial end surface or are distributed evenly along the radial circumferential surface, and
a shape or a size of the plurality of holes or projections changes in a predefined sequence in at least one circumferential section along the circumference of the axial end surface or along the radial circumferential surface.

18. The measurement assembly according to claim 11, wherein the plurality of holes and projections has identical shape or size, and is distributed along a circumference of the axial end surface or along the radial circumferential surface,
wherein a distribution of the plurality of holes or projections changes by number or sequence in at least one circumferential section along the circumference of the axial end surface or along the radial circumferential surface.

19. The measurement assembly according to claim 11, wherein the measurement signals comprise impulses generated when the plurality of holes or projections passes by the at least two sensors and induces eddy currents in the at least two sensors.

20. A motor vehicle transmission comprising:
a first shift element disk capable of rotating;
a second shift element disk capable of rotating or being stationary;
at least two sensors disposed adjacently to one another; and
an encoding including a plurality of holes or projections on an axial end surface or a radial circumferential surface of the first shift element disk, the encoding configured to pass by the at least two sensors when the first shift element disk rotates;
wherein when the plurality of holes passes by the at least two sensors, the at least two sensors generate measurement signals to detect a direction of the rotation of the first shift element disk, a rate of the rotation of the first shift element disk, a rotational position of the first shift element disk, an axial position of the first shift element disk, and an axial spacing between the first shift element disk and the second shift element disk.

21. A drive for a motor vehicle comprising an electric machine, the drive comprising:
at least two sensors disposed adjacently to one another;
a rotating assembly capable of rotating with respect to the at least two sensors, the rotating assembly including an axial end surface or a radial circumferential surface; and
an encoding including a plurality of holes or projections on the axial end surface or the radial circumferential surface, the encoding configured to pass by the at least two sensors during a rotation of the rotating assembly,
wherein when the encoding passes by the at least two sensors, the at least two sensors generate measurement signals for determining a direction of the rotation, a rate of the rotation, a rotational position, and an axial position of the rotating assembly.

22. The drive according to claim 21, wherein the drive is a hybrid drive or electric drive.

23. The drive according to claim 21, wherein the axial position of the rotating assembly is determined from amplitudes of the impulses of the measurement signals.

24. The drive assembly according to claim 21, wherein the rate of rotation of the rotating assembly is determined from a frequency of the impulses of the measurement signals.

25. The drive according to claim 21, wherein the direction of rotation and the rotational position of the rotating assembly are determined from a sequence and a number of impulses of the measurement signals.

26. The drive according to claim 21, wherein the at least two sensors includes induction spirals or induction coils.

27. The drive according to claim 21, wherein the plurality of holes and projections are identical in shape or size, and are distributed along a circumference of the axial end surface or along the radial circumferential surface,
wherein a distribution of the plurality of holes or projections changes by number or sequence in at least one circumferential section along the circumference of the axial end surface or along the radial circumferential surface.
